(19) United States
(12) Patent Application Publication
(10) Pub. No.: US 2012/0002059 A1
(43) Pub. Date: Jan. 5, 2012

(54) Video Feedback Loop

(76) Inventors: Isaac Levy, New York, NY (US); Tal Shalom, Fair Lawn, NJ (US); Meir Sela, Cresskill, NJ (US); Stephan Wenger, Hillsborough, CA (US)

(21) Appl. No.: 13/159,102

(22) Filed: Jun. 13, 2011

Related U.S. Application Data
(60) Provisional application No. 61/360,200, filed on Jun. 30, 2010.

(51) Int. Cl. H04N 17/00

(52) U.S. Cl. 348/192; 348/E17.001

(57) ABSTRACT

Techniques to enable the monitoring, quality control, automatic verification of content use, confidence monitoring, and/or net-return monitoring of a forward video transmission between an originating site or content producer (e.g., a TV studio) and distribution or consuming site(s). In particular, the distribution site(s) return video signals based on the forward video transmission, from various handover points back to the originating site, to provide information on the video quality at the handover point.

### CROSS REFERENCE TO RELATED APPLICATIONS

The application claims the benefit of priority from U.S. Provisional Application Ser. No. 61/360,200, filed Jun. 30, 2010, which is hereby incorporated by reference herein in its entirety.

### BACKGROUND OF THE INVENTION

1. Field of Technology

The invention relates to bi-directional video transmission in a TV distribution environment, e.g., cable TV (CATV) and Internet Protocol TV (IPTV).

2. Background Art

Subject matter related to the present application can be found in co-pending U.S. patent application Ser. No. 61/289,249, filed Dec. 22, 2009 and entitled “System And Method For Interactive Synchronized Video Watching,” which is hereby incorporated by reference herein in its entirety.

In this disclosure, the transmission of audio-visual signals (the “content”) between an originating site and a consuming site is called content distribution or video distribution. A typical distribution path of audio-visual content in a TV environment can involve at least the following entities: content factories that produce the content, affiliates, involved in the mass distribution of content, and consumers.

First, the audio-visual content is produced and packaged by a content factory, alternatively known as a content producer or content provider (e.g., a TV studio). This involves two conceptual steps: (1) content acquisition, in which audio-visual content is acquired, e.g., by capturing a scene with, for example, a camera and microphone, or by using some form of data transmission between the content factory and another content factory (e.g., another studio); and (2) content processing or packaging, in which the content factory can process the content by, for example, mixing different pieces of content together, adding logos, and similar. The content factory can operate in real-time, i.e., for live content, or it can operate according to a non real-time schedule for non-live content (e.g., stored in a video database). One example of a large content factory in the United States at the time of writing is CNN.

Once the content has been produced, it is distributed to the consumer. Again, two general steps are involved. First, the content factory makes the content available to one or more entities, known as affiliates or licensees, which are involved in the mass distribution of the content. Second, an affiliate can take content from many content providers, and makes the content available to consumers over a network operated by the affiliate, often after some limited adaptation of the content. The adaptation can involve, for example, format conversion, splicing in of commercials, adding logos of the affiliate and/or enabling digital rights management protection; however, the substance of the content is left intact. One example of a large affiliate at the time of writing in the United States is Comcast. The affiliate can rebroadcast the content sourced from the content provider in real-time, or the affiliate can store the content locally and rebroadcast it at a time of the affiliate's choosing (which can be governed by consumer demands, e.g., video-on-demand, or by requirements set by the content factory (e.g. early distribution of pre-recorded shows, to be made available to the consumer only from a certain day/time.).

Finally, at the consumer site, the content is received and can be presented to the consumer. In the past, this was strictly a real-time process; if a user were tuned into a given channel at a given time, he/she would see the program, but otherwise not. More recently, sophisticated mechanisms have been deployed that allow the user to store, time-shift, and view content independent from the original broadcast time, e.g., digital video recorder (DVR).

Content factory, affiliate, and consumer are in most cases independent entities with different business interests. The links between each of these entities are known as “handover points”. It is also conceivable that a content distribution involves several content factories and affiliates simultaneously. For example, when a World Cup soccer game is filmed in one country, a local content factory can provide the original content. That content can be conveyed to a second content factory, which can add, for example, commentary in another country's language. The edited content can be available to a first affiliate that conveys the content not only to its own connected consumers (over, for example, cable TV), but also to a second affiliate that redistributes the same content over a different network infrastructure (for example, the Internet). In this case, handover points exist between all the content factories, affiliates, and all connected consumers.

Today, the vast majority of content distribution mechanisms use uni-directional transmission only. As shown in FIG. 1, for example, a content factory (101), such as CNN or Fox News, can create live video content from a video source (102) (e.g., a camera or any other appropriate source). This content can be transmitted over a distribution network (103) (e.g., leased lines, satellite connections, and increasingly, Internet links with managed quality of service (QoS)) to the head ends of an affiliate (104). The affiliate can use uni-directional transmission mechanisms and protocols, which can be based on CableLabs specifications, to distribute the content to the consumers via, for example, cable television (CATV). On the consumer premises, TVs (106), sometimes with the help of set-top-boxes and/or other hardware, present the content to the consumer.

Outside very specialized quality monitoring settings, there is no common feedback mechanism between any of the involved entities—content factory, affiliate, and consumer. Even in the specialized quality monitoring setting, normally only abstract information about network quality or, at best, highly subjective video quality assessments by users, is available. For example, a chosen group of consumers can have access to specialized equipment which they can use to convey subjective video quality information among other data, such as channel preference. Network equipment can include quality monitoring based on Simple Network Management Protocol (SNMP) queries to network elements. If the content transmission uses an IP/UDP/RTP [RFC 3550], available at http://www.ietf.org/rfc/rfc3550.txt, protocol stack, feedback can be provided using RTCP extended receiver reports, for example according to [RFC 3611], available at http://www.ietf.org/rfc/rfc3611.txt.

While this abstract information can tell a market researcher or a network engineer a lot about the quality of the programming and the network quality side of the distribution, the more content-oriented video engineers, producers, and other media personnel in the studio are less readily able to interpret this abstract information. However, content-oriented media professionals can identify—and possibly correct, using tools at their disposal—quality problems if these problems are shown to them in the form of video.

Media quality assessment can also be relevant to bi-directional video transmission techniques. Normally, television uses only audio and video media; no other human senses are stimulated. Accordingly, measurement of audio and video quality is sufficient. Many formal media quality measurement metrics and technologies have been proposed, and a few have seen some adoption, though not necessarily in a TV distribution environment.

Subjective and objective media quality measurement techniques can be distinguished; subjective techniques are not of much relevance in the context of this invention. Subjective techniques require a pool of human observers; the larger and the less uniform (with respect to age, socialization, location, language and cultural preferences, etc.) the pool population is, the more reliable can be the results. This makes reliable subjective tests very expensive and often time-consuming.

Three broad categories of objective techniques can be distinguished:

(1) Full reference techniques use an original signal and a signal under test to determine the quality;

(2) Reduced reference techniques use an original signal that has been converted to consume less bandwidth—e.g., by reducing the audio bandwidth, taking only short intervals at full bandwidth, reducing the video frame rate at full resolution, reducing the video resolution, and so forth—and a signal under test (suitably down-sampled) to determine the quality; and

(3) No reference techniques, operate only on a signal under test, and typically use heuristic techniques, such as detecting the presence of blocking or other coding artifacts.

Full reference techniques are considered more reliable than reduced reference techniques, which, in turn, are considered more reliable than no reference techniques.

### SUMMARY

Disclosed herein are techniques to enable the monitoring, quality control, automatic verification of content use, confidence monitoring, and/or net-return monitoring of a forward video transmission between an originating site or content producer (e.g., a TV studio) and distribution or consuming site(s). In particular, the distribution site(s) return video signals based on the forward video transmission from various handover points back to an originating site to provide information on video quality at the handover point.

Media professionals have experience in adjusting video related parameters based on observation of video. Offering media professionals insight into video quality as available at any handover point can help them to improve the video quality for the population of consumers.

The placement of the quality monitoring can be important. The closer the monitored handover point is to the content factory, the more consumers can benefit from adjustments that are being made. On the other hand, the closer the monitored handover point is to the consumer, the more conclusive the monitoring can be with respect to the quality observed by the user, as the potentially adverse effects on the quality of all entities between the original content source and the close-to-the-consumer handover point are included in the monitoring. Accordingly, a content feedback loop from consumers' premises—whether only a selected few, or a large population—back to the studio can be helpful to improve the overall experience for all the consumers.

However, the feedback loop can also originate at any other suitable location in the forward transmission path between the content factory and the consumer, such as, for example, the affiliate's head end, strategically chosen locations inside the affiliate's own network such as any satellite uplink or downlink sites, and similar locations. The feedback can result in an improvement in the content quality perceived by the consumer through manual adjustment of media coding related parameters. For example, content-oriented media professionals can adjust color, brightness, and similar settings based on information from the feedback loop. Alternatively or in addition, automatic tools can be used to tune quality related parameters of the distributed video based on the feedback information. For example, automatized equipment can adjust color, brightness, and similar settings based on information received from the feedback loop.

The feedback loop can also be utilized for purposes other than quality control. While many more applications can be feasible, three such uses should be introduced, using the handover point between a content factory and an affiliate as an example, are: confidence monitoring, assurance of handover, and net return.

“Confidence monitoring” relates to the monitoring of the complete content transmission chain between studio and head-end. By feeding back the content to the studio, which can be in an augmented form, equipment failures in the forward transmission path can be readily identified in the studio through distortion or absence of the content that is being fed back.

In “assurance of handover”, the feedback loop can help to resolve disputes over content availability and/or quality between the content factory and the affiliate. If the content factory, or an independent trusted third party (such as an escrow agent) can keep records of the content that has been sent and that is being fed back to it, and if there is an agreement between content factory and affiliate that these records are authentic (which can, for example, be ensured by having the recordings made by a trusted third party at the content factory's premises), the affiliate may not be in the position to relay complaints it may have received over bad content quality back to the content factory, unless the recordings show such bad quality as well.

“Net return” can be understood in the context of a live show being produced in a content factory. While the content factory has a good understanding of its own manipulation of the video, the media professionals involved at the content factory are unaware of the manipulation that happens downstream, i.e., in an affiliate. If the affiliate would provide the content factory with a feedback link after having introduced its own processing, the professionals in the content factory can use this input to fine-tune the presentation so as to accommodate the modifications introduced by the affiliate. For example, if the affiliate introduced a large logo on the top right side of the screen, the content factory could react by ensuring that no important content is placed in the screen real-estate used by the large logo.

Many other uses of a feedback loop can also be implemented.

Feedback loops in the aforementioned sense have been technically feasible for a long time, using the same network technology for the feedback as is used for the forward transmission. However, until now, feedback loops have been impermissibly costly and therefore hardly, if ever, been used. Modern Internet-based content coding and distribution techniques, as disclosed herein and based on technologies first used in video conferencing, help to overcome this cost barrier, thereby enabling the use of feedback as a day-to-day tool in video distribution.

### BRIEF DESCRIPTION OF THE DRAWINGS

FIG. 1 is a block diagram of content distribution in accordance with the prior art.

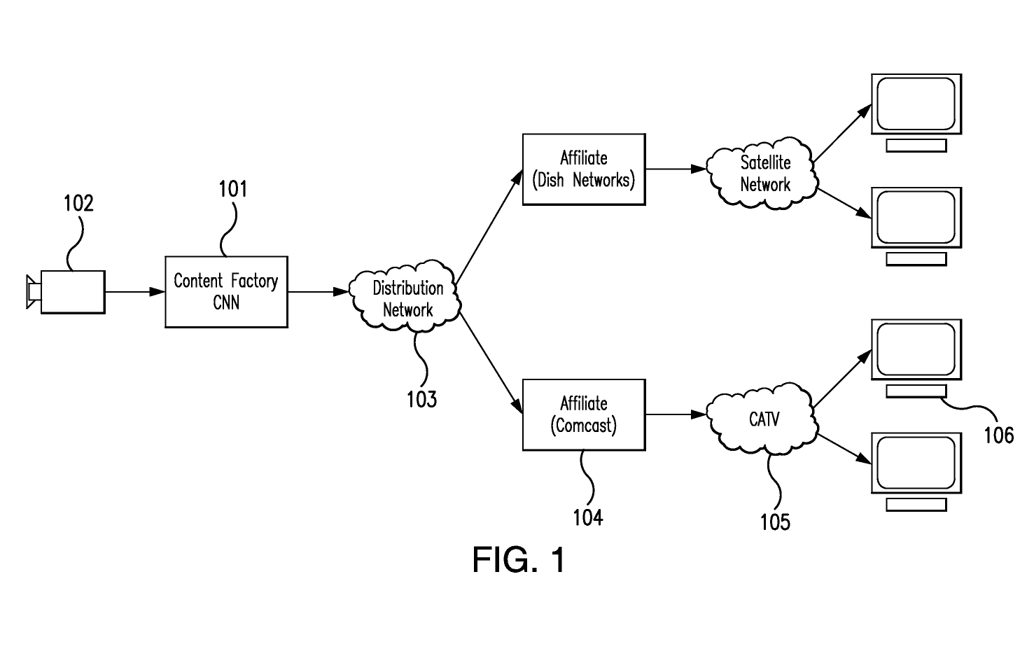

FIG. 2 is a block diagram of a video feedback loop in accordance with the present invention.

FIG. 3 is a block diagram of a video feedback loop in accordance with the present invention.

FIG. 4 is a block diagram of a video feedback loop in accordance with the present invention.

Throughout the drawings, the same reference numerals and characters, unless otherwise stated, are used to denote like features, elements, components or portions of the illustrated embodiments. Moreover, while the disclosed invention will now be described in detail with reference to the figures, it is done so in connection with the illustrative embodiments.

### DETAILED DESCRIPTION OF THE INVENTION

The present invention discloses techniques to enable, among other applications, the monitoring, quality control, automatic verification of content use, confidence monitoring, and/or net-return monitoring of a forward video transmission between a content factory and distribution or consuming site(s). The distribution or consuming site(s) can return video signals based on the forward video transmission from various handover points back to the originating site to provide information on the video quality at the handover point.

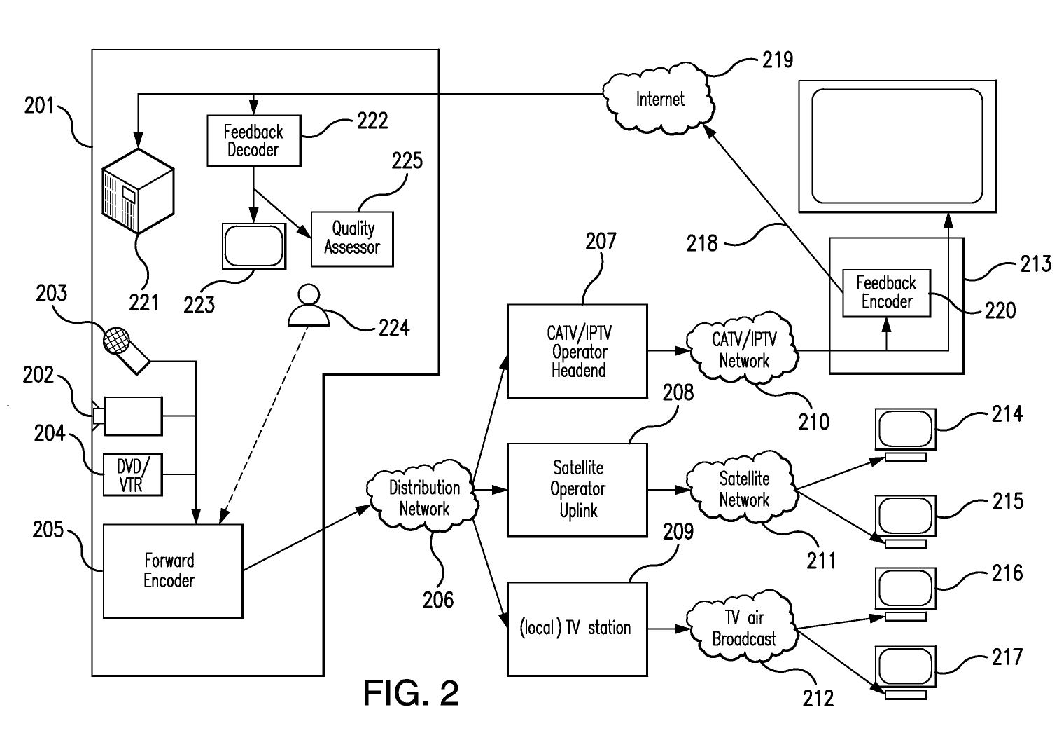

FIG. 2 illustrates an exemplary setup according to the invention, wherein the feedback originates from a consumer site. A content factory (201) prepares the content. In a live setting, the content can be recorded, for example, by one or more cameras (202) and microphones (203). The content can also be pre-recorded on analog or digital media (204) such as a video tape recorder or a DVD. From any of the aforementioned sources, the content is either already available in a suitable compressed format, or it can be compressed (i.e., encoded) by an encoder (205). Depicted in FIG. 2 is the case where encoding is required. The output of the encoder comprises the signal to be conveyed over the distribution network (206) to the affiliate(s).

The distribution network (206) can be a traditional TV distribution network, comprising satellite link segments, dedicated fiber, perhaps an MPLS provisioned IP link, or another form of link that offers good QoS and reliability, though it can be at very high cost. The details of the distribution network are not relevant for the present invention and, therefore, it is not discussed in further detail. While the network elements that make up the hardware of the distribution network can control some form of quality monitoring, the end-to-end video quality over this network can, in most cases, not be monitored at all. The video distribution in the distribution network can be bi-directional or uni-directional—the common business practice today is uni-directional content distribution; the invention does not change this aspect of the environment.

Links of the distribution network terminate at sites that, on one hand, can have the technical and financial resources to connect to the distribution network and, on the other hand, can require the QoS and reliability the distribution network offers. Examples of those sites are the head-ends of affiliates: CATV or IPTV operator head-ends (207), satellite operator uplinks (208) or (local) TV stations (209). Other sites can include other content factories (e.g., content factories in foreign countries which require content manipulation for language simultaneous translation or to enable censorship), as well as archiving sites.

Affiliates such as CATV, IPTV, satellite operators, or (local) TV stations run their own networks (210, 211, 212). In case of CATV, the network is typically a private coaxial cable network. IPTV operator networks can be based on physical cable or fiber owned and operated by the operator, or the operator can rely on Internet infrastructure and run a virtual network only. The “network” in the case of a satellite operator consists of one or more uplinks that convey the signal to satellite(s), the satellite(s) rebroadcast the content back to the earth's surface where it is received by antenna dishes in, or co-located with, the consumer's premises. A TV station operates one or more transmitting facilities for a terrestrial broadcast, which convey the signal wirelessly to where it may be received by antennas at, or co-located with, the consumer's premises. Not all the details mentioned above are relevant for the invention. However, they share the characteristic that the content distribution is uni-directional, even if the physical or virtual network structure can allow bi-directional communication.

The affiliate's network links terminate close to the consumer's premises, and are connected to consumer-operated (and can be consumer-owned) endpoint equipment (213, 214, 215, 216, 217) such as TVs and set-top boxes.

In one embodiment of the invention, at least one of the endpoints (213) also maintains a connection (218), through a suitable network (219), back to the content factory (201). The suitable network (219) can be, for example, the Internet. Over the connection (218), an audio-visual feedback signal can be conveyed back to the content factory (201). The audio-visual signal can be derived from the content that the content factory has originally sent over the video distribution network (206) to an affiliate (e.g., (207)), and sent over the affiliate's network (e.g., (210)) to the endpoint (213). The audio-visual feedback signal can be encoded using a user-premises based encoder (220) that can be integrated in the endpoint equipment (213).

In the same or another embodiment, in the content factory, the feedback signal can be recorded for future use in a recorder (221). The recorder can be, for example, a PC with a hard drive of sufficient size to record a sufficiently long period of feedback audio-visual data, or any other suitable device, and can be operated by a third party. The recording can be used in an “assurance of handover” scenario.

In the same or another embodiment, in the content factory, the feedback signal can be decoded by a decoder (222) and displayed at a monitoring station (223). The display can be observed by a media professional (224) who can adjust parameters of the studio setting (e.g., lighting), or the settings of the forward encoder (205) (i.e., a “confidence monitoring” scenario), or can adjust non-technical parameters (e.g., the placement of talents, etc.) to reflect information obtained by observing the display (i.e., a “net return” scenario).

In the same or another embodiment, in the content factory, the feedback signal can be decoded by a decoder (222) and fed into a comparator and video quality assessor (225). While comparator and quality assessor can be implemented in separate entities, they are advantageously integrated into a single device so to avoid the high bandwidth links that would otherwise have to be available between them. The comparator can compare the feedback signal against the time-shifted original signal. The time shift can be manually or automatically set such that it compensates for the transmission delay of both forward and feedback transmission. The comparator can alert the media professional (224) if it detects, for example, any of the following cases: no feedback signal (can be caused by a breakdown of equipment or a network condition), bad quality (i.e., a large divergence between the quality of the time-shifted original signal and the feedback signal, which can be caused by non-fatal equipment problems such as loose connectors, or by network conditions of insufficient quality), or acceptable quality. If the feedback signal is conveyed in essentially the same quality as the forward signal, the quality assessor may be employing full reference audio-visual quality measurement techniques. In many cases, however, it is more cost efficient if the feedback signal is conveyed in a lower quality than the forward signal. In this case, reduced reference audio-visual quality measurement techniques can be employed. Both are known to be considerably more reliable as the no reference tools used in prior art end-to-end media quality assessment. The quality measurement can be used in a “confidence monitoring” scenario, or in an “assurance of handover” scenario.

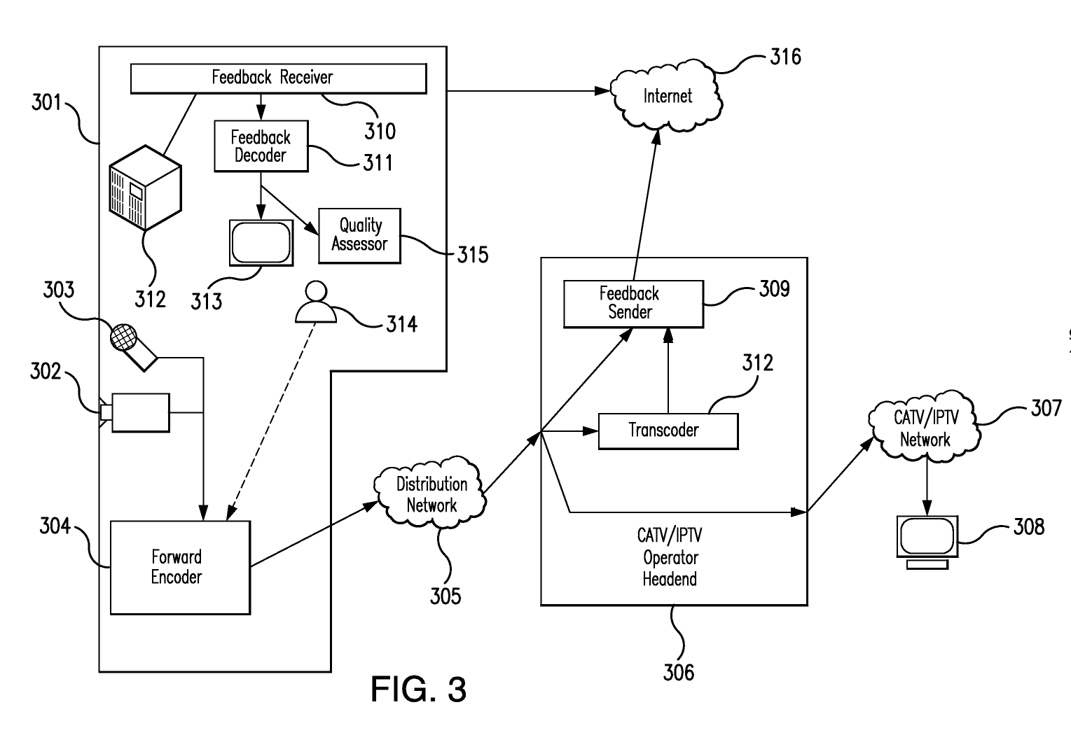

FIG. 3 depicts another exemplary setup according to the invention. In this setup, the forward media distribution chain is considered similar to the previous example. A content factory (301) acquires the content from an appropriate source or sources, here, for example, through real-time capture of a talent by a camera (302) and microphone (303). The camera/microphone signals are processed by a forward encoder (304) coupled to a distribution network (305). The distribution network (305) feeds affiliate sites (306) such as satellite uplinks, CATV head ends, and so on. The affiliate sites (306) feed the consumer distribution network (307), to which consumer receiver equipment (308), such as TVs and similar equipment, is linked.

In this example, the feedback originates not at the end customer, but at an intermediary handover point in the media distribution chain. While any place in any of the intermediary sites or in the networks involved could act as feedback originators, there are two categories of common choices. The first category includes handover points in the distribution chain topology where there are commercial boundaries. For example, the content factory can be run by one commercial entity and the affiliate by another commercial entity. It can facilitate the commercial relationships if there is a clear understanding of what quality of media has been delivered by the content factory (301) to the affiliate (306). Specifically, the feedback can be helpful for troubleshooting the technology at the handover point or the links leading to the handover point. Further, sometimes an affiliate can have a dispute with the content factory over who is responsible for a bad quality signal at the handover point. The feedback link may assist in an amicable resolution of such an dispute.

The second category of choices for feedback originators includes handover points at the boundaries of different media transport technologies. For example, a feedback loop can originate at a site that terminates a fiber channel (with a very high QoS and reliability) and originates a consumer-level satellite channel (with less QoS and reliability)—even if both channels are owned or operated by the same commercial entity, such as an affiliate. One use for the second category is confidence monitoring.

In FIG. 3, the feedback loop originates at a point where there is both a commercial and a technical boundary. Specifically, in this example, an affiliate's CATV head end (306) can be operated by a different commercial entity than the content factory (301), and the network technologies are also different (highly reliable distribution network (305), vs. consumer-grade reliable CATV network (307)).

In the affiliate's CATV head end, any of the following technologies can be used to enable the feedback, alone or in combination. The forward signal can be sent back to the content factory (301) in unmodified form by a feedback sender (309) over a suitable network (316), for example, the Internet. In the content factory (301), the forward signal is received by a feedback receiver (310) and decoded by a feedback decoder (311). Alternatively, or in addition, the forward signal can be transcoded by a transcoder (312) into a different media representation, and then sent by the feedback sender (309) to the studio (301) using the network (316) for similar processing. Here, the term “transcoder” is employed broadly; transcoding can involve the process of media reproduction to the pixel/audio sample domain and re-encoding in the same or a different media coding format, or it can involve only manipulation of the compressed signal, i.e., by dropping layers, frames, audio samples, or a combination of the two. More details are provided later in this disclosure.

In the content factory, activities similar to those as discussed above in FIG. 2 can apply to enable similar uses. Specifically, the media received by the feedback receiver (310) can be stored in a recorder (312) for future use (such as for future handover assurance), decoded by decoder (311) and displayed on display (313) (and the analogs for audio) to be monitored by a human audio-visual professional (314) for net-return purposes, or fed into a comparator and quality assessor (315) which can implement similar technologies, as discussed above, for confidence monitoring.

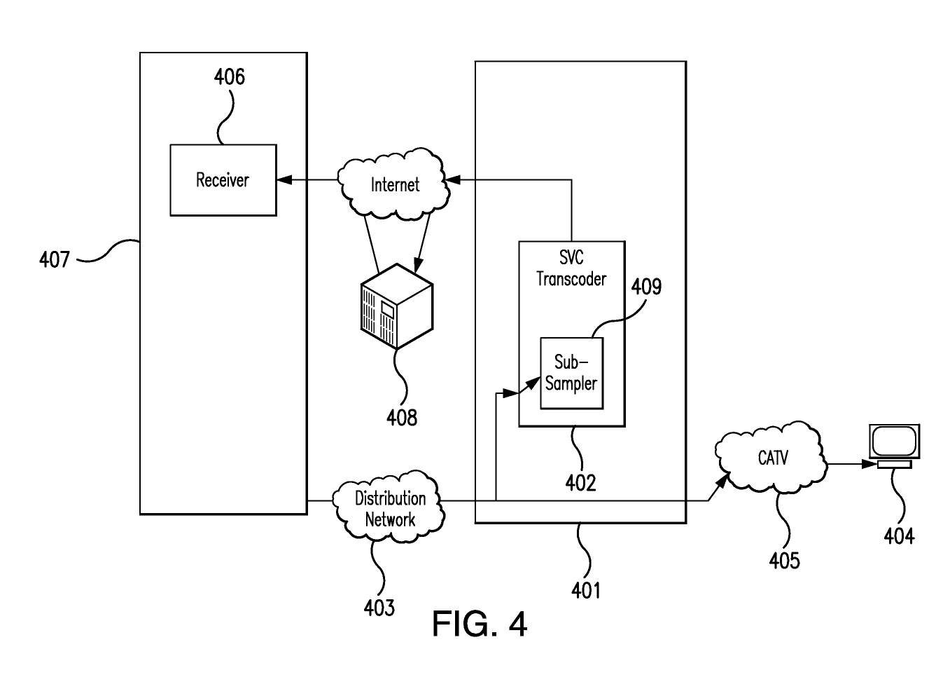

FIG. 4 illustrates the feedback transmission in more detail. The feedback loop, according to the invention, is not a necessary component in the sense that it generates revenue for any of the involved parties. Therefore, it is very cost sensitive. Accordingly, it can be commercially advantageous to use a cheap—at least when compared to the very high quality and very costly distribution network—alternative for this network. While the invention can be based on other suitable networks, such as mobile networks, as well, the remainder of this disclosure uses the Internet as an exemplary network that carries the feedback information. The Internet is not only comparatively inexpensive, but also is widely available. However, for improved cost efficiency, Internet traffic can be conveyed “best effort”; that is, IP packets can get lost during the transmission, and this loss is not necessarily the result of an equipment failure or under-provisioning, but a normal operation point of the network.

Traditional IPTV transmission technologies, such as those in commercially available IPTV systems, can be unsuitable for use over best effort connections on the Internet, as they rely on the QoS of a managed IP network. Other (e.g., streaming) technologies are known to cope with the loss characteristics of the Internet, but they add delay, often in the order of magnitude of several seconds. For many of the applications previously mentioned (e.g., confidence monitoring and net return), a delay of several seconds introduced by the feedback loop would render the feedback loop less useful. Accordingly, for improved results, the feedback transmission should be conveyed over a best effort network that has packet losses, but with low delay.

Video conferencing technologies, especially those based on Scalable Video Coding (SVC), are well known to be highly suitable for the high quality transmission of video over best effort Internet links and at low delay. According to one aspect of the invention, advantageously, the video transmission aspect of the feedback loop is conveyed in the form of SVC coded video, using infrastructure as, for example, disclosed in co-pending patent application Ser. No. 61/289,249.

As depicted in FIG. 4, in the same or another embodiment of the invention, the feedback-originating site (401) includes an SVC transcoder (402). The SVC transcoder (402) receives the coded forward content from the distribution network (403) (and can also perform further decoding and/or encoding steps, and forward the content to sinks, as the case may be, e.g., the consumer distribution network (405) or receiver equipment (404) at the consumer site. The SVC transcoder (402) first, at least partially, decodes the forward non-SVC coded content, and encodes an SVC coded representation of the same content.

The SVC transcoder can also contain a sub-sampler (407) that can temporally or spatially sub-sample the full resolution forward content to a format as required in the content factory. For example, if the content factory wishes to run a full reference quality assessment, then the sub-sampler may be inactive. However, if the content factory wishes to run only a reduced reference quality assessment, then the sub-sampler can reduce the spatiotemporal resolution of the forward content to such a resolution as required by the content factory. Sub-sampling reduces the number of pixels per second that need to be coded, which, in turn, reduces the both number of bits that need to be conveyed over the feedback link, and the number of processor cycles required for the coding, and thereby may reduce transmission and equipment cost. The nature of the sub-sampling is advantageously chosen based on the content characteristics. For a sports channel, for example, temporal sub sampling is unadvisable as sports content benefits greatly from high temporal fidelity. On the other hand, for a sitcom TV show format, a temporal sub sampling is appropriate, but spatial sub sampling may be inadvisable, as spatial detail is of high importance in this content format.

For temporal sub-sampling, frame or field skip techniques have been shown to provide good performance at a low overhead.

For spatial sub-sampling, techniques involving at least 4 tap two-dimensional filters can be advantageously used to provide a reasonable approximation of the quality even after sub-sampling. Straightforward pixel-drop techniques can introduce too much aliasing to allow for a useful quality measurement back in the content factory.

Returning briefly to FIG. 3, it should be understood to a person skilled in the art that whatever sub-sampling technique, if any, is employed in the transcoder (312), an identical sub-sampling technique should be used in the quality assessor (315).

Returning to FIG. 4, the SVC transcoder (402) can generate a plurality of layers, of which, depending on the network conditions, one or more are conveyed to the receiver (406) located in the content factory (407), advantageously using one or more Scalable Video Coding Servers (SVCS) (408) located “in” the network. The SVCS (408) and its functionalities have been disclosed in co-pending patent application Ser. No. 61/289,249; its main purpose is the management of layers and local repair of lost packets in packet streams of individual layers.

In another embodiment, the SVC transcoder (402) can be replaced with a traditional encoder. On segments of the Internet that provide a good QoS, this may result in coded video arriving at the content factory (407). However, as network conditions deteriorate, the use of SVC becomes increasingly advantageous.

In another embodiment, the forward content can be conveyed back to the content factory in (on the video plane) unmodified form using reliable transmission protocols, e.g., the Transmission Control Protocol (TCP). This functionality can be implemented, for example, where the content factory requires full reference quality assessment. The resources required by the network, in this case, are considerable, and significant delay can be introduced, but the feedback information is guaranteed to be exactly the same as the forward information, eliminating all reasons for confusion or discussions in commercial disputes when used in a handover assurance scenario.

If the forward coded content is already in an SVC coded format, the function of the transcoder can be as simple as reducing the number of layers to be sent over the feedback link back to the content factory such that the capacity of the feedback link can sustain the layers.

1. A method of monitoring a forward video transmission, the method comprising:
transmitting a first video signal from a first point to a second point over a first link;
generating a second video signal derived from the first video signal at the second point; and
transmitting the second video signal from the second point to the first point over a second link, wherein the first link and the second link are not established on the same network.

2. The method of claim 1, wherein the first link comprises a uni-directional link.

3. The method of claim 1, wherein the first link comprises part of a distribution network.

4. The method of claim 1, wherein, the second link comprises a link established on the Internet.

5. The method of claim 1, wherein the first point comprises at least one of a content factory, a site of an affiliate, a commercial handover point, or a technical handover point.

6. The method of claim 1, wherein the second point comprises at least one of a site of an affiliate, a commercial handover point, a technical handover point, or an endpoint.

7. The method of claim 1, wherein the second video signal comprises a signal adapted for at least one of confidence monitoring, net return monitoring, or assurance of handover.

8. The method of claim 1, the method further comprising:
presenting a time-shifted version of the first video signal and a second video signal to a user.

9. The method of claim 1, the method further comprising:
comparing a time-shifted version of the first video signal with the second video signal.

10. The method of claim 9, the method further comprising:
determining an indication of quality based on the results of the comparison.

11. The method of claim 1, wherein the second video signal comprises a video signal encoded in a scalable video coding format.

12. A non-transitory computer-readable medium having a set of instructions programmed to perform:
transmitting a first video signal from a first point to a second point over a first link;
generating a second video signal derived from the first video signal at the second point; and
transmitting the second video signal from the second point to the first point over a second link, wherein the first link and the second link are not established on the same network.

13. The non-transitory computer-readable medium of claim 12, the medium further comprising instructions such that the second video signal comprises a video signal adapted for at least one of confidence monitoring, net return monitoring, or assurance of handover.

14. A forward video transmission monitoring system comprising:
a first link between a first point and a second point; and
a second link between the first point and the second point;
wherein the first point comprises a point configured to transmit a first video signal from the first point to the second point over the first link, the second point comprises a point configured to generate a second video signal derived from the first video signal and transmit the second video signal from the second point to the first point over the second link, and wherein the first link and the second link are not established on the same network.

15. The system of claim 14, wherein the first link comprises a uni-directional link.

16. The system of claim 14, wherein the first link comprises part of a distribution network.

17. The system of claim 14, wherein, the second link comprises a link established on the Internet.

18. The system of claim 14, wherein the first point comprises at least one of a content factory, a site of an affiliate, a commercial handover point, or a technical handover point.

19. The system of claim 14, wherein the second point comprises one of a site of an affiliate, a commercial handover point, a technical handover point, or an endpoint.

20. The system of claim 14, wherein the second video signal comprises a signal adapted for at least one of confidence monitoring, net return monitoring, or assurance of handover.

21. The system of claim 14, wherein the second point comprises a point configured to present a time-shifted version of the first video signal and a second video signal to a user.

22. The system of claim 14 wherein the second point comprises a point configured to compare a time-shifted version of the first video signal with the second video signal.

23. The system of claim 22 wherein the second point comprises a point configured to determine an indication of quality based on the results of the comparison.

24. The system of claim 14, wherein the second video signal comprises a signal encoded in a scalable video coding format.
